(19) United States
(12) Patent Application Publication
(10) Pub. No.: US 2012/0221272 A1
(43) Pub. Date: Aug. 30, 2012

(54) QUALITY ESTIMATION APPARATUS, QUALITY ESTIMATION METHOD AND NON-TRANSITORY COMPUTER-READABLE MEDIUM STORING PROGRAM

(75) Inventors: Ken Ueno, Tokyo (JP); Ryusei Shingaki, Tokyo (JP); Shizu Sakakibara, Kanagawa (JP)

(73) Assignee: KABUSHIKI KAISHA TOSHIBA, Tokyo (JP)

(21) Appl. No.: 13/405,508

(22) Filed: Feb. 27, 2012

(30) Foreign Application Priority Data
Feb. 28, 2011 (JP) 2011-042464

(51) Int. Cl. G06F 19/00

(52) U.S. Cl. 702/81

(57) ABSTRACT

According to one embodiment, a quality estimation apparatus includes: a storage module which stores designation information for designating inspection targets to be subjected to sampling inspection in estimation targets including the inspection targets and non-inspection targets, characteristic values obtained by the sampling inspection of the inspection targets and criterion information for determining qualities of the inspection targets based on the characteristic values; a threshold value calculator which calculates threshold values indicating qualities of the inspection targets from the characteristic values of the inspection targets by using the criterion information; and a clustering module which classifies the estimation targets in clusters so that the clusters have probability distributions with the threshold values used as a variable.

CROSS REFERENCE TO RELATED APPLICATION(S)

The application is based upon and claims the benefit of priority from Japanese Patent Application No. 2011-042464 filed on Feb. 28, 2011; the entire content of which are incorporated herein by reference.

### FIELD

Embodiments of the present invention relate to a quality estimation apparatus, a quality estimation method and a non-transitory computer-readable medium storing a program that causes a computer to execute the quality estimation method.

### BACKGROUND

In semiconductor manufacturing, components formed on a wafer are subjected to quality inspection (such as electric characteristic inspection, etc.) by a halfway inspection step. Because a large number of components are generally formed on a wafer, it is difficult to grasp accurate qualities of the respective components based on inspection of all the components.

There is consequently known a technique of preparing past wafer processing-time data (e.g. quality tendency) as prior knowledge and estimating qualities of components based on the data. It is however difficult to estimate qualities of components, for example, when the qualities show a tendency to be out of prior knowledge.

### BRIEF DESCRIPTION OF THE DRAWINGS

Embodiments of the present invention will be described in detail based on the following figures, wherein:

FIG. 1 is a diagram of configuration of a quality estimation apparatus according to a first embodiment;

FIG. 2 is a block diagram of the quality estimation apparatus according to the first embodiment;

FIG. 3 is a view for explaining clusters;

FIG. 4 is a flow chart of an inspection module and a quality rank calculator in the quality estimation apparatus according to the first embodiment;

FIG. 5 is a view for explaining a component ID;

FIG. 6 is a view for explaining a neighborhood region;

FIG. 7 is a flow chart of a clustering module in the quality estimation apparatus according to the first embodiment;

FIGS. 8A to 8C are views for explaining a quality estimation module in a quality estimation apparatus according to the first embodiment;

FIG. 9 is a block diagram of the quality estimation apparatus according to a second embodiment;

FIG. 10 is a view for explaining operation of an inspection target calculator in the quality estimation apparatus according to the second embodiment;

FIG. 11 is a block diagram of a quality estimation apparatus according to a third embodiment;

FIGS. 12A to 12E are views for explaining operation of an inspection target calculator in the quality estimation apparatus according to the third embodiment.

### DETAILED DESCRIPTION OF THE EMBODIMENTS

A quality estimation apparatus includes: a storage module which stores designation information for designating inspection targets to be subjected to sampling inspection in estimation targets including the inspection targets and non-inspection targets, characteristic values obtained by the sampling inspection of the inspection targets and criterion information for determining qualities of the inspection targets based on the characteristic values; a threshold value calculator which calculates threshold values indicating qualities of the inspection targets from the characteristic values of the inspection targets by using the criterion information; and a clustering module which classifies the estimation targets in clusters so that the clusters have probability distributions with the threshold values used as a variable.

Embodiments of the invention will be described below.

### First Embodiment

For example, in a process of inspecting a wafer 1 on which components 3 such as a magnetic head, etc. are formed, a quality estimation apparatus according to this embodiment performs sampling inspection (hereinafter referred to as inspection) of some components 3 on the wafer 1 to thereby obtain an inspection result (e.g. electric characteristic such as resistance).

Although direct quality ranks are given to components 3 which have been already inspected, estimated quality ranks are given to remaining components 3 which have not been inspected yet. On this occasion, all the components 3 are classified (subjected clustering) into clusters each of which has a probability distribution with the quality rank as a variable (hereinafter referred to as rank probability distribution) and which are different in quality tendency (variation or combination of quality ranks). The same quality rank is given to components 3 which have not been inspected yet and which are conclusively classified into the same cluster.

Incidentally, the term “quality ranks of components 3” means a yardstick for expressing quality given in accordance with electric characteristic. Description will be made here on the assumption that the four quality ranks of high rank (A), middle rank (B), low rank (C) and fault (F) are provided.

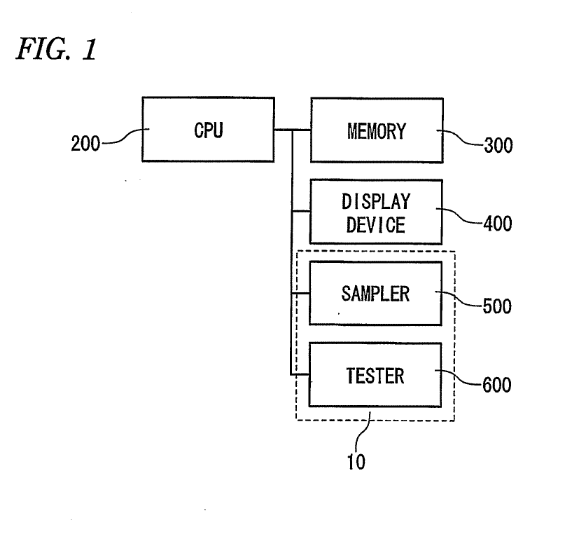

FIG. 1 is a diagram of configuration of the quality estimation apparatus. The quality estimation apparatus according to this embodiment has an inspection module 10, a CPU 200, a memory 300, and a display device 400. The inspection module 10 performs quality inspection of components 3. The CPU 200 performs an arithmetic process which will be described later. The memory 300 stores information necessary for an arithmetic operation in advance, and stores a result of the arithmetic operation temporarily. The display device 400 displays the result of the arithmetic operation.

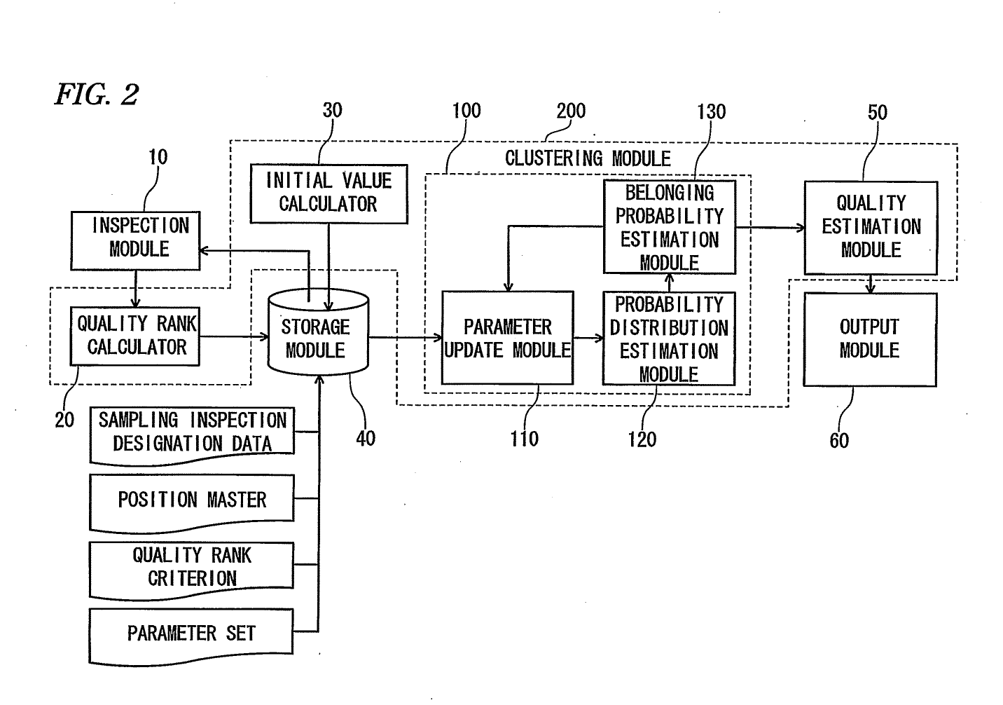

The quality estimation apparatus according to this embodiment will be described below in detail with reference to FIGS. 2 to 8.

FIG. 2 is a block diagram for explaining an internal system of the CPU 200 in the quality estimation apparatus. The quality estimation apparatus shown in FIG. 2 has an inspection module 10, a quality rank calculator 20, an initial value calculator 30, a storage module 40, a clustering module 100, and a quality estimation module 50. The inspection module 10 has a sampler 500, and a tester 600. The sampler 500 extracts a wafer 1 from a step and loads the wafer 1 into the tester 600. The tester 600 examines a part of components 3. The quality rank calculator 20 calculates quality ranks of inspected components 3 based on an inspection result obtained by the inspection module 10. The initial value calculator 30 calculates initial values necessary for clustering. The storage module 40 stores the initial values. The clustering module 100 performs clustering of all the components 3. The quality estimation module 50 estimates conclusive quality ranks of the components 3.

If necessary, the quality estimation apparatus further may have an output module 60 which outputs an estimation result of conclusive quality ranks of the components 3 estimated by the quality estimation module 50.

Incidentally, as shown in FIG. 2, the CPU 200 plays the roles of the quality rank calculator 20, the initial value calculator 30, the clustering module 100 and the quality estimation module 50. The memory 300 plays the role of the storage module 40. The display device 400 plays the role of the output module 60.

In this embodiment, the inspection module 10 inspects components 3 designated as targets of sampling inspection and obtains a result of the inspection. The quality rank calculator 20 calculates the quality ranks of the inspected components 3 based on the inspection result.

The clustering module 100 calculates an expected value of a rank probability distribution of each cluster by using the quality ranks of the inspected components 3 based on a predetermined probability statistical model. The clustering module 100 updates the probability of classifying components 3 into each cluster based on the expected values of the rank probability distributions and estimates the cluster into which components 3 are classified conclusively.

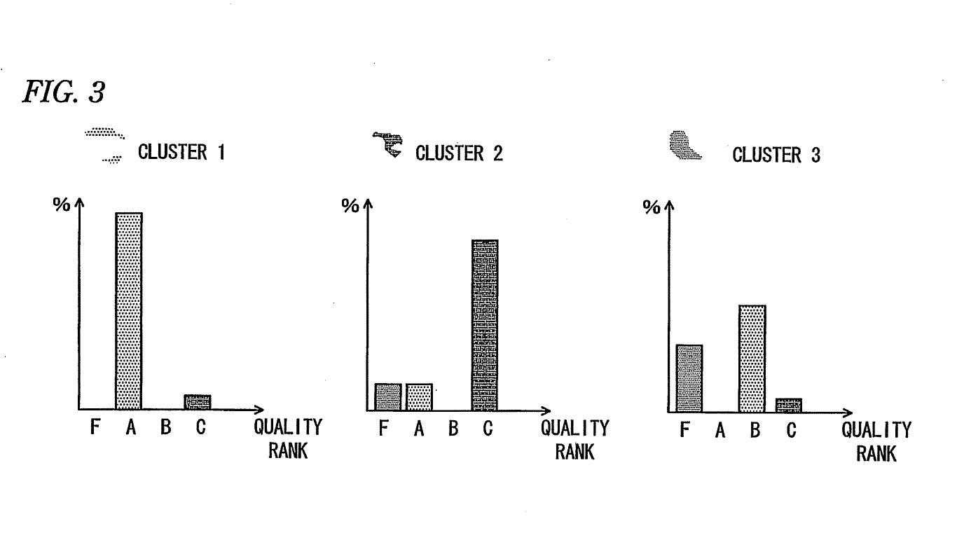

FIG. 3 shows an example of clusters. Here is shown a state where three clusters are formed, that is, a cluster (high quality cluster 1) in which quality rank A is the highest, a cluster (low quality cluster 2) in which quality rank C is the highest and a cluster (frequently defective cluster 3) in which quality rank F is not lower than a predetermined value are formed as quality tendencies.

Conclusively, the quality estimation module 50 gives quality ranks of components 3 based on the clusters into which components 3 are classified by the clustering module 100.

### (Inspection Module and Quality Rank Calculator)

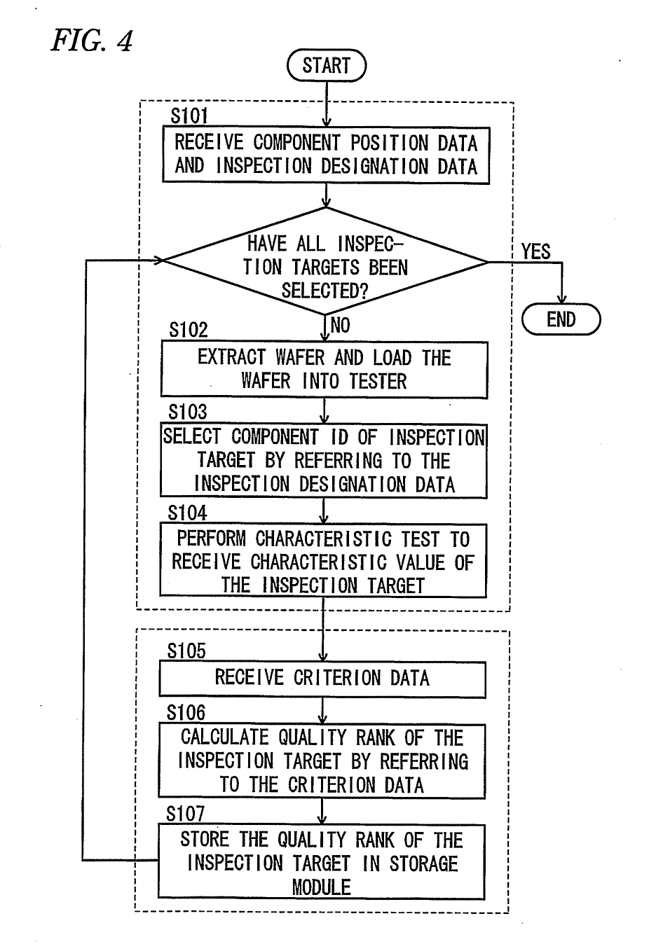

Operations of the inspection module 10 and the quality rank calculator 20 will be described below with reference to a flow chart shown in FIG. 4.

The inspection module 10 receives component position data (Table 1) and inspection designation data (Table 2) from the storage module 40 (S101). The component position data and the inspection designation data are given in the storage module 40 in advance. The component position data indicates positions of components 3 on the wafer 1. The inspection designation data designates components 3 to be inspected.

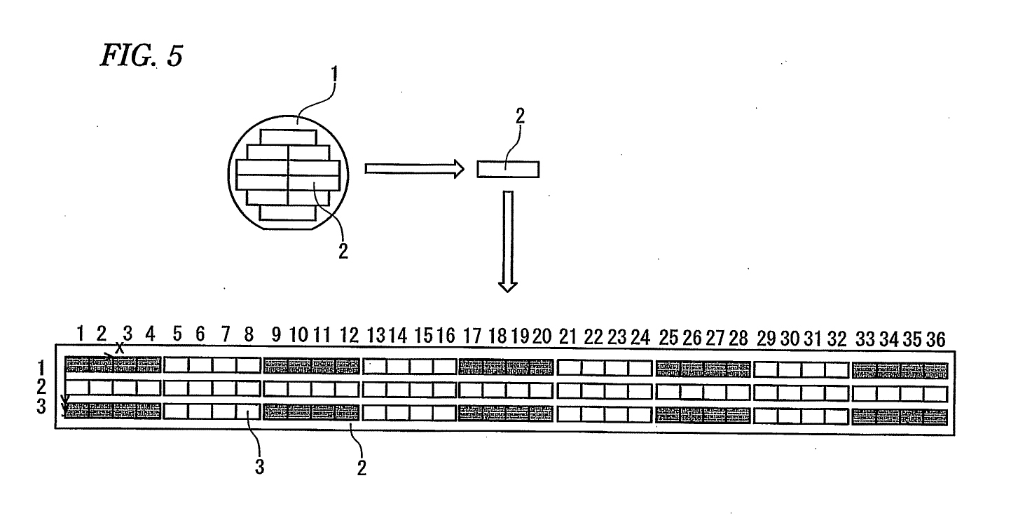

In this embodiment, as shown in FIG. 5, one wafer 1 is separated into ten rectangular blocks 2. Each block 2 is further separated into a matrix of indexes (e.g. a total of 108 indexes in FIG. 5). Each index indicates a component 3 formed.

Component ID's are allocated to the components 3 in order to identify the components 3 uniquely. The component ID of each component 3 contains a wafer ID for identifying a wafer 1 to which the component 3 belongs, a block ID for identifying a block 2 to which the component 3 belongs, and index values (i, j) for identifying an index to which the component 3 belongs.

As shown in FIG. 5, the index values (i, j) are expressed here as coordinates in an ij coordinate system having an upper left index as its origin.

For example, the component ID of a component 3 with a wafer ID of 1, a block ID of 7 and index values of (8, 3) is given as 1-7-8-3.

As shown in Table 1, the component position data contains a block ID, index values (i, j), and coordinates (x, y) expressing the position of an index identified by the index values. As shown in FIG. 5, the coordinates (x, y) are expressed as coordinates in an xy coordinate system which has physical dimensions (assumed to be mm here) in the condition that the upper left of a component 3 formed on an index having index values (1, 1) is taken as the origin of the xy coordinate system.

For example, it is to be understood that a component 3 having a component ID given as 1-7-8-3 is formed in a position 16 mm distant in an x-axis direction and 3 mm distant in a y-axis direction from the origin O of a block 2 having a block ID given as 7 in a wafer 1 having a wafer ID given as 1.

TABLE 1

| Component ID | | | | x-coordinate | y-coordinate |
|---|---|---|---|---|---|
| Wafer ID | Block ID | x-index | y-index | (mm) | (mm) |
| 1 | 7 | 1 | 1 | 2.0 | 1.0 |
| 1 | 7 | 1 | 2 | 2.0 | 2.0 |
| 1 | 7 | 1 | 3 | 2.0 | 3.0 |
| 1 | 7 | 2 | 1 | 4.0 | 1.0 |
| 1 | 7 | 2 | 2 | 4.0 | 2.0 |
| 1 | 7 | 2 | 3 | 4.0 | 3.0 |
| 1 | 7 | 3 | 1 | 6.0 | 1.0 |
| 1 | 7 | 3 | 2 | 6.0 | 2.0 |
| 1 | 7 | 3 | 3 | 6.0 | 3.0 |
| 1 | 7 | 4 | 1 | 8.0 | 1.0 |
| 1 | 7 | 4 | 2 | 8.0 | 2.0 |
| 1 | 7 | 4 | 3 | 8.0 | 3.0 |
| 1 | 7 | 5 | 1 | 10.0 | 1.0 |
| 1 | 7 | 5 | 2 | 10.0 | 2.0 |
| 1 | 7 | 5 | 3 | 10.0 | 3.0 |
| 1 | 7 | 6 | 1 | 12.0 | 1.0 |
| 1 | 7 | 6 | 2 | 12.0 | 2.0 |
| 1 | 7 | 6 | 3 | 12.0 | 3.0 |
| 1 | 7 | 7 | 1 | 14.0 | 1.0 |
| 1 | 7 | 7 | 2 | 14.0 | 2.0 |
| 1 | 7 | 7 | 3 | 14.0 | 3.0 |
| 1 | 7 | 8 | 1 | 16.0 | 1.0 |
| 1 | 7 | 8 | 2 | 16.0 | 2.0 |
| 1 | 7 | 8 | 3 | 16.0 | 3.0 |

As shown in Table 2, the inspection designation data contains a component ID, and an inspection flag which indicates whether the component 3 identified by the component ID is a target of inspection or not. Here, the inspection flag is set as “yes” if the component 3 is a target of inspection, but the inspection flag is set as “no” if the component 3 is not a target of inspection.

For example, the inspection flag is set as “yes” so that about one tenth of the total number of components 3 is targets of inspection.

For example, a component 3 identified by a component ID given as 1-7-1-1 in Table 2 is a target of inspection because the inspection flag of the component 3 is set as “yes”. On the other hand, a component 3 identified by a component ID given as 1-7-4-2 is not a target of inspection because the inspection flag of the component 3 is set as “no”.

TABLE 2

| Component ID | | | | |
|---|---|---|---|---|
| Wafer ID | Block ID | x-index | y-index | Sampling Inspection Flag |
| 1 | 7 | 1 | 1 | yes |
| 1 | 7 | 1 | 2 | no |
| 1 | 7 | 1 | 3 | yes |
| 1 | 7 | 2 | 1 | yes |
| 1 | 7 | 2 | 2 | no |
| 1 | 7 | 2 | 3 | yes |
| 1 | 7 | 3 | 1 | yes |
| 1 | 7 | 3 | 2 | no |
| 1 | 7 | 3 | 3 | yes |
| 1 | 7 | 4 | 1 | yes |
| 1 | 7 | 4 | 2 | no |
| 1 | 7 | 4 | 3 | yes |
| 1 | 7 | 5 | 1 | no |
| 1 | 7 | 5 | 2 | no |
| 1 | 7 | 5 | 3 | no |
| 1 | 7 | 6 | 1 | no |
| 1 | 7 | 6 | 2 | no |
| 1 | 7 | 6 | 3 | no |
| 1 | 7 | 7 | 1 | no |
| 1 | 7 | 7 | 2 | no |
| 1 | 7 | 7 | 3 | no |
| 1 | 7 | 8 | 1 | no |
| 1 | 7 | 8 | 2 | no |
| 1 | 7 | 8 | 3 | no |

Incidentally, in the following description, components 3 having the inspection flag set as “yes” in inspection designation data are called “inspection targets 3a”, components 3 having the inspection flag set as “no” are called “estimation targets 3b”, and all components 3 inclusive of the two types of components are simply called “components 3”.

The sampler 500 extracts a wafer 1 and loads the wafer 1 into the tester 600 (S102).

Then, the tester 600 selects a component ID of an inspection target 3a o by referring to the inspection designation data (S103). On this occasion, the tester 600 can select component ID's in order of description in the inspection designation data.

The tester 600 specifies the position where the inspection target 3a of the component ID selected by the step S102 is formed on the wafer 1, by referring to the component position data, and inspects the inspection target 3a, for example, based on an electric characteristic test or the like to receive a characteristic value (S104). On this occasion, when a plurality of characteristic values are received, the inspection target 3a can be inspected based on different tests. Incidentally, the characteristic value is stored in the storage module 40.

The quality rank calculator 20 receives criterion data (Table 3) from the storage module 40 (S105). The criterion data is given to the storage module 40 in advance and is a criterion for determining the quality rank.

As shown in Table 3, the criterion data contains a quality rank, and numerical values of upper and lower limits of the characteristic value when the quality rank is given. The characteristic value is a numerical result directly obtained from inspection. Accordingly, the criterion data indicates the quality rank given to the inspected component 3 based on the numerical result obtained from inspection.

One characteristic value may be contained in the criterion data or a plurality of characteristic values may be contained in the criterion data as shown in Table 3.

TABLE 3

| | Upper Limit | Lower Limit | Upper Limit | Lower Limit |
|---|---|---|---|---|
| | of Charac- | of Charac- | of Charac- | of |
| | teristic | teristic | teristic | Characteristic |
| Quality Rank | Value 1 | Value 1 | Value 2 | Value 2 |
| High Rank | — | 41.3 | — | 4.1 |
| (A) | | | | |
| Middle Rank | 41.3 | 31.6 | 4.1 | 2.9 |
| (B) | | | | |
| Low Rank | 31.6 | 27.6 | 2.9 | 1.3 |
| (C) | | | | |
| Fault (F) | 27.6 | — | 1.3 | — |

Then, the quality rank calculator 20 determines the quality rank in which the characteristic value as an inspection result obtained by the step S104 is contained, by referring to the criterion data, and therefore calculates the determined quality rank as a quality rank yij of an inspection target 3a formed on an index having index values (i, j) (S106).

On this occasion, when two characteristic values (e.g. characteristic value 1 and characteristic value 2) are contained in the criterion data, for example, lower one of quality ranks in which the respective characteristic values are contained may be calculated as a quality rank yij of the inspection target 3a.

For example, when the characteristic value 1 and characteristic value 2 of the inspection target 3a obtained from inspection are 40.0 and 3.0 respectively, a middle rank (B) is calculated as a quality rank yij of the inspection target 3a.

The quality rank yij of the inspection target 3a calculated by the quality rank calculator 20 as described above is stored in the storage module 40 (S107).

After the quality rank yij of one inspection target 3a is calculated in this manner, the steps S102 to S107 are repeated until quality ranks yij of all the inspection targets 3a are calculated.

### (Initial Value Calculator)

The initial value calculator 30 sets an initial value of the estimated value xij of a component 3 formed on an index having index values (i, j), and stores the initial value in the storage module 40. The estimated value xij indicates a cluster k which is one of K clusters and into which the component 3 is estimated to be classified. For example, the initial value of the estimated value xij may be set at random based on random number generation.

The initial value calculator 30 further sets an initial value of the probability (hereinafter referred to as belonging probability) q(xij=k) of classifying the component (i, j) into the cluster k, and stores the initial value in the storage module 40. For example, when the maximum cluster number K which will be described later is used, q(xij=k)=1/K can be calculated as an initial value on the assumption that the component 3 belongs to respective clusters equiprobably.

### (Storage Module)

The storage module 40 stores not only the estimated value xij and the belonging probability q(xij=k) of the component 3 but also a parameter set given in advance and required for clustering.

Here, the parameter set contains quality rank number L, maximum cluster number K, neighborhood region size R, and inter-neighborhood correlation coefficient C.

The quality rank number L indicates the number of ranks classified as quality ranks. In this embodiment, description will be made on the assumption of L=4 as described above.

The maximum cluster number K indicates the maximum number of distributions classified as rank probability distributions, that is, the maximum number of clusters formed by clustering.

The neighborhood region size R is a parameter for determining how macroscopically the quality rank tendency of inspection targets 3a present in the surrounding region is considered when the quality rank of an estimation target 3b is estimated. Specifically, the neighborhood region size R expresses the width of one side of a rectangular region around an estimation target 3b. The rectangular region determined by the neighborhood region size R is defined as the neighborhood region of the estimation target 3b located in the center.

In this case, the neighborhood (i′, j′) of the estimation target 3b located in index values (i, j) can be represented by the following expression.

i=(R−1)/2≦i′≦i+(R−1)/2, j−(R−1)/2≦j′≦j+(R−1)/2. [Expression 1]

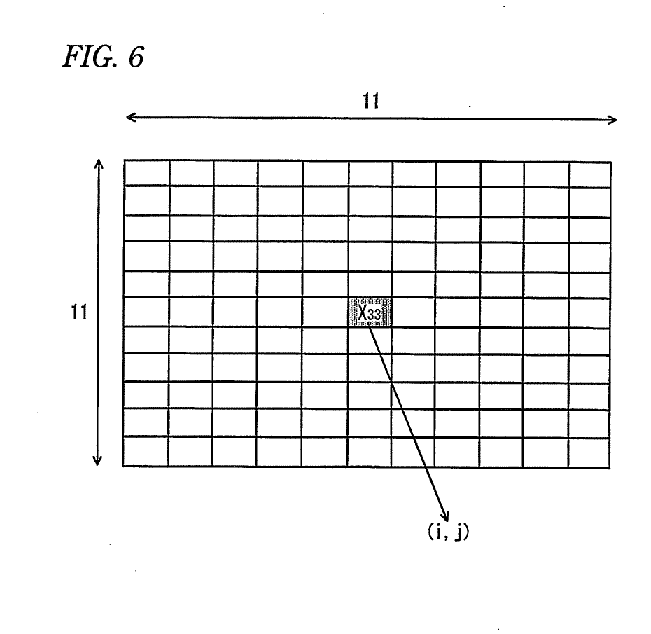

FIG. 6 is a view showing the neighborhood region of a component 3 located in index values (i, j) when the neighborhood region size R is 11. In this case, let Wij be a matrix (11 rows and 11 columns) of quality ranks yij of inspection targets 3a located in the neighborhood region of a component 3 formed on an index having index values (i, j).

The inter-neighborhood correlation coefficient C is a parameter for determining how the quality rank tendency in the neighborhood region determined by the neighborhood region size R has influence on estimation of the quality rank of the estimation target 3b.

In the following description, a component 3 formed in index values (i, j) is regarded as component n (1≦n≧N), and the estimated value of the component n is regarded as xₙ. Here, N represents the total number of components 3 in a wafer 1.

### (Clustering Module)

The clustering module 100 has a parameter update module 110, a probability distribution estimation module 120, and a belonging probability estimation module 130. The parameter update module 110 updates parameters required for clustering. The probability distribution estimation module 120 calculates probability distributions required for clustering. The belonging probability estimation module 130 calculates probabilities of belonging of components 3 to clusters.

In this embodiment, the clustering module 100 performs clustering of components 3 by estimating probability distributions of respective clusters based on a variation Bayes method (e.g. Non-Patent Document 1). On this occasion, a Dirichlet process is used as a probability statistical model.

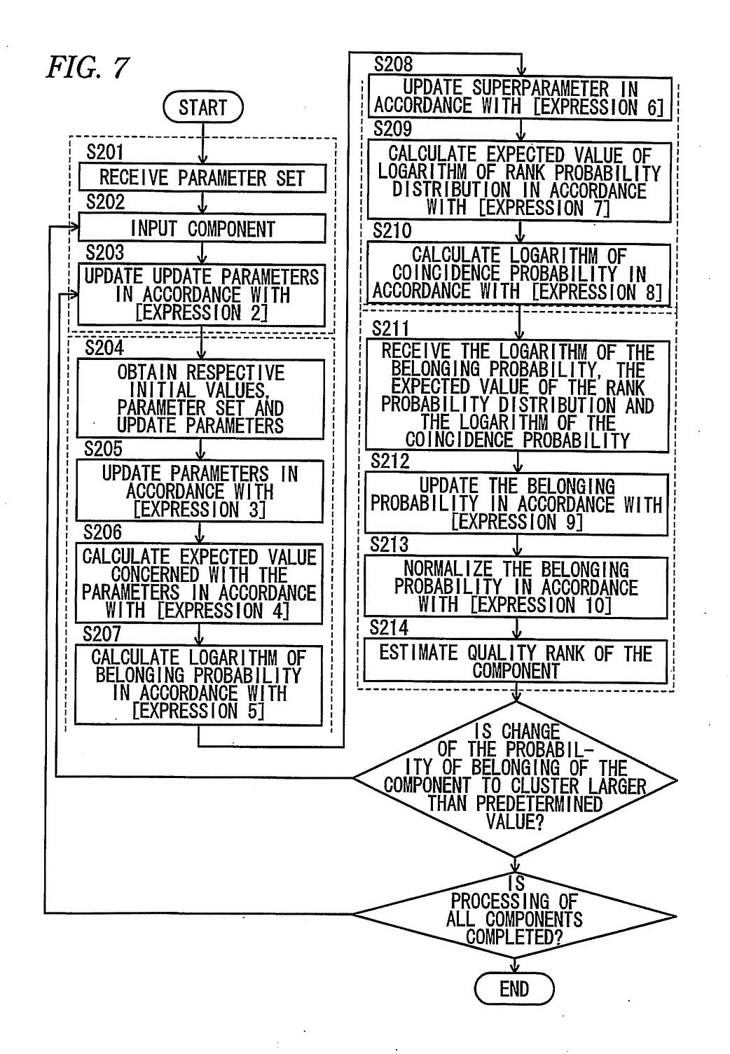

Operation of the clustering module 100 will be described below in detail with reference to a flow chart shown in FIG. 7.

The parameter update module 110 receives the aforementioned parameter set from the storage module 40 (S201). Then, the parameter update module 110 selects a component 3 (S202). On this occasion, for example, components 3 can be selected in order of component ID.

Then, the parameter update module 110 updates update parameters concerned with the Dirichlet process in accordance with the following expression based on the aforementioned input (S203). Incidentally, on this occasion, any real numbers are given as initial values of the update parameters in advance.

η₁←η₁+K−1

η₂←η₂+Σₖ₌₁^{K-1}[ψ(β_{k,2})−ψ(β_{k,1}+β_{k,2})]. [Expression 2]

In the aforementioned expression, Ψ(·) represents a digamma function.

In the aforementioned expression, β_{k,1} and β_{k,2} are parameters concerned with the probability of belonging of an estimation target to a cluster k. Any real numbers are given as initial values of the parameters in advance.

Then, the probability distribution estimation module 120 receives the initial value of the belonging probability of each component 3 as an input and calculates the logarithm of the belonging probability.

A specific calculation method will be described below.

The probability distribution estimation module 120 receives initial values of belonging probabilities and a parameter set from the storage module 40 and receives update parameters updated in accordance with [Expression 2] from the parameter update module 110 (S204).

Then, the probability distribution estimation module 120 calculates expected values of parameters concerned with the belonging probabilities for all clusters based on the inputs in accordance with the following [Expression 3] and [Expression 4].

First, the parameters β_{k,1} and β_{k,2} are updated in accordance with the following expression based on the update parameters η_{1 i} and η₂ updated in accordance with [Expression 2] and the initial values of the belonging probabilities q (S205).

$${β}_{k , 1} ← 1 + {\sum }_{n = 1}^{N} q ( {x}_{n} = k ) \\ {β}_{k , 2} ← \frac{{η}_{1}}{{η}_{2}} + {\sum }_{{k}^{′} = k + 1}^{K} {\sum }_{n = 1}^{N} q ( {x}_{n} = {k}^{′} ) . \qquad [ Expression 3 ]$$

Then, expected values are calculated in accordance with the following expression based on the parameters β_{k,1} and β_{k,2} updated in accordance with [Expression 3] (S206). Incidentally, <·>x in the following expression represents an expected value (average) in x.

<log νₖ>νₖ←Ψ(β_{k,1})−Ψ(β_{k,1}+β_{k,2}),

<log(1−νₖ)>νₖ←Ψ(β_{k,2})−Ψ(β_{k,1}+β_{k,2}). [Expression 4]

The logarithm of the belonging probability πₖ in the Dirichlet process is calculated in accordance with the following expression based on the expected values calculated as described above (S207).

log πₖ(ν)=<log νₖ>νₖ+Σₖ₌₁^{K-1}<(1−νₖ)>νₖ. [Expression 5]

Then, the probability distribution estimation module 120 calculates the expected value of the logarithm of a rank probability distribution which is a quality rank probability distribution of a cluster k, based on the quality ranks yₙ of inspection targets.

Specifically, expected values of logarithms of rank probability distributions for all clusters are calculated in accordance with [Expression 6] and [Expression 7].

First, a superparameter ω of rank probability is updated in accordance with the following expression (S208). Here, any real number is given as the initial value ω₀ of the superparameter in advance.

ω_{k,l}←ω₀+Σₙ₌₁^{N}q(xₙ=k)I[yₙ−l]. [Expression 6]

The expected value of the logarithm of the rank probability distribution θ is calculated based on the thus updated superparameter in accordance with the following expression (S209). Incidentally, in the aforementioned expression, L represents the number of quality ranks, and I represents a quality rank. In the aforementioned expression, I[·] is an indicator function which returns 1 only in the case of yₙ=1 but returns 0 in the other case.

<log θ_{k,l}>θ_{k,l}←Ψ(ω_{k,l})'1Ψ(Lω₀+Σₙ₌₁^{N}q(xₙ=K)). [Expression 7]

Then, the probability distribution estimation module 120 calculates the logarithm of the probability p that the probability distribution of quality ranks yₙ of inspection targets 3a present in the neighborhood region of a component 3 will coincide with a cluster k (hereinafter referred to as coincidence probability) for all clusters in accordance with the following expression (S210).

log p(xₙ=k|W(n);C)←C(Σₓ_{ₘ}_{∈W(n)}I[xₘ=k]). [Expression 8]

Incidentally, in the aforementioned expression, I[·] is an indicator function which returns 1 only in the case of xₘ=k but returns 0 in the other case. In the aforementioned expression, C represents an inter-neighborhood correlation coefficient.

The belonging probability estimation module 130 receives the logarithm of the belonging probability, the expected value of the logarithm of the rank probability distribution and the logarithm of the coincidence probability calculated for all clusters by the probability distribution estimation module 120 as described above (S211).

Then, the belonging probability estimation module 130 updates the logarithm of the belonging probability q indicating the probability of belonging of a component 3 to each cluster in accordance with the following expression based on the above description (S212). Although updating is performed here based on addition of logarithms, each probability and a corresponding expected value may be multiplied directly.

log q(xₙ=k)←log p(xₙ=k)+log πₖ(ν)+<log θ_{k,l}>θ_{k,l}. [Expression 9]

As described above, the logarithm of the belonging probability is updated in consideration of the tendency in the neighborhood region. Then, the belonging probability is divided by the sum of belonging probabilities concerned with all clusters as in the following expression to thereby perform normalization (S213).

$$q ( {x}_{n} = k ) ← \frac{exp ( log q ( {x}_{n} = k ) )}{{\sum }_{k = 1}^{K} exp ( log q ( {x}_{n} = k ) )} . \qquad [ Expression 10 ]$$

Then, while the cluster k of the maximized probability in the belonging probability distribution of a component 3 is regarded as the estimated value of the component 3, that is, as the cluster to which the component 3 belongs, the quality rank having the maximum probability in the rank probability distribution of the cluster to which the component 3 belongs is set as the quality rank of the component 3 (S214).

The clustering module 100 repeats the steps S203 to S214. That is, in the step S203 after the step S214, the update parameters η₁ and η₂ are updated newly in accordance with [Expression 2] based on the parameters β_{k,1} and β_{k,2} which were updated one cycle ago.

Then, in the step S205, the parameters β_{k,1} and β_{k,2} are updated newly in accordance with [Expression 3] based on the update parameters η₁ and η₂ updated newly and the belonging probability updated one cycle ago. Then, processing in the steps S206 to S214 is executed.

The clustering module 100 calculates the difference between the newly updated belonging probability and the previous belonging probability to the updating, and terminates the repetitive calculation when the difference converges into a value not larger than a predetermined value.

The aforementioned process is applied to all components 3 so that quality ranks are conclusively estimated for all components 3 in accordance with [Expression 8] in consideration of quality ranks of inspection targets 3a in the neighborhood region of each component 3.

### (Quality Estimation Module and Output Module)

The quality estimation module 50 gives conclusive quality ranks to components 3 based on the quality ranks of the components estimated based on repetitive calculation by the clustering module 100.

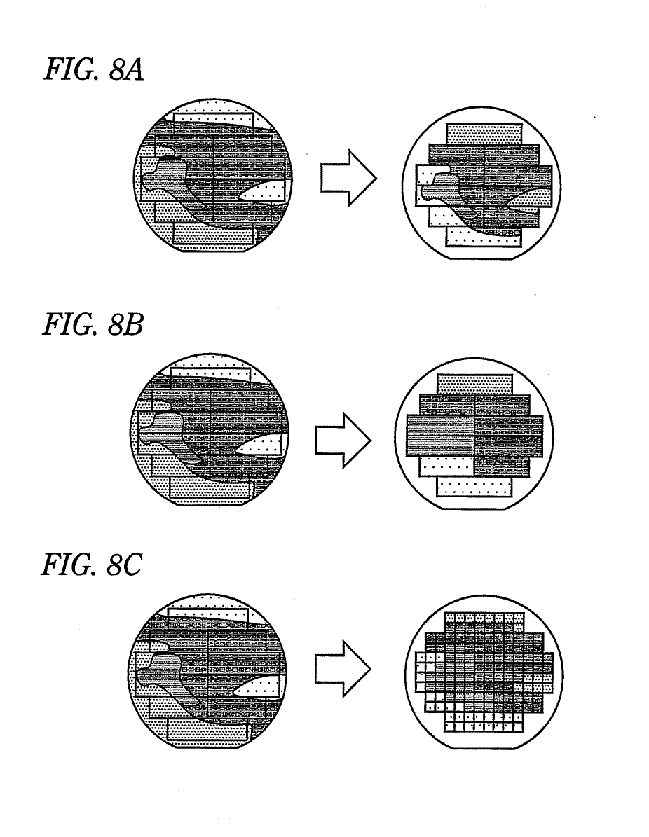

On this occasion, for example, the quality ranks of the components 3 estimated by the clustering module 100 may be used directly as the conclusive quality ranks of the components 3 (FIG. 8A).

Alternatively, for example, the quality ranks of the components 3 in each block 2 estimated by the clustering module 100 may be collected so that the most frequent quality rank can be regarded as the quality rank of the block 2 as a whole (FIG. 8B). In this case, as shown in FIG. 8B, the estimated quality rank distribution roughly coincides with the distribution received from the clustering module 100.

When quality ranks are to be estimated more finely than the above description, for example, blocks may be divided more finely as shown in FIG. 8C. FIG. 8C is a view showing the case where each block is further divided into 12-16 parts. In this manner, it is to be understood that the estimated quality rank distribution approaches to the distribution received from the clustering module 100.

For example, the output module 60 is a display device etc. which displays the conclusive quality ranks of the components estimated by the quality estimation module 50.

Although this embodiment has been described in the case where quality ranks of components 3 take discrete values, quality ranks of components 3 may be regarded as vectors which take continuous values like characteristic values per se of inspection targets 3a inspected by the inspection module 10.

In this case, the probability distribution estimation module 120 calculates logarithmic likelihood of yₙ under each cluster k based on the average and covariance matrix of quality ranks yₙ of inspection targets 3a in the cluster k instead of the rank probability distribution calculated in the steps S208 and S209.

Then, the logarithm of the belonging probability is updated in accordance with the following expression based on the logarithmic likelihood and the belonging probability and coincidence probability calculated in the steps S207 and S210. In the following expression, the third term in the right side represents the logarithmic likelihood.

log q(xₙ=k)←log p(xₙ=k)+log πₖ (ν)+log p(yₙ|μₖ. Σₖ). [Expression 11]

In accordance with the quality estimation apparatus according to this embodiment, more accurate qualities of all components formed on a wafer can be estimated by performing as few sampling inspections as possible at the time of processing of one wafer without necessity of prior knowledge.

### Second Embodiment

A quality estimation apparatus according to this embodiment adds inspection targets 3a newly from estimation targets 3b when there is a quality rank of a probability substantially equal to the rank probability distribution of each cluster after the estimated value estimated by the clustering module 100 converges into a value.

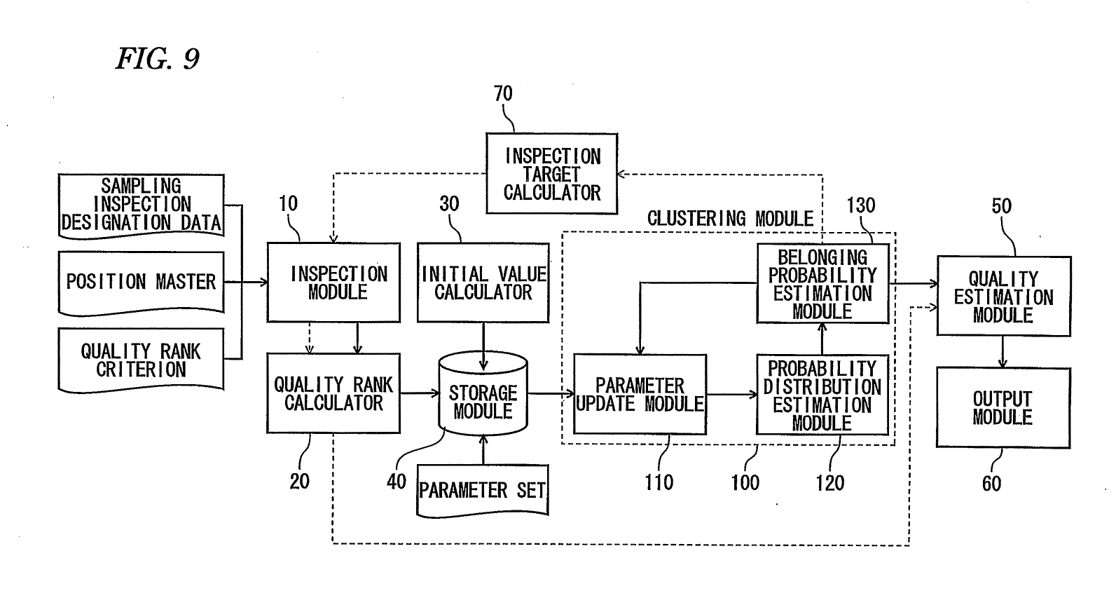

FIG. 9 is a block diagram of the quality estimation apparatus according to this embodiment. Incidentally, the same parts in configuration as those in the first embodiment are referred to by the same numerals for the sake of omission of description.

The quality estimation apparatus according to this embodiment has, in addition to the configuration of the quality estimation apparatus according to the first embodiment, an inspection target calculator 70 which calculates inspection targets 3a to be added newly.

The inspection target calculator 70 uses a quality rank of the highest probability in the rank probability distribution of the cluster and other quality ranks as pairs of quality ranks and generates distributions of the number of components (hereinafter referred to as number distributions) in each pair based on the pair and the number of components belonging to the cluster.

Then, the number distributions of each pair are verified with respect to whether there is a rate difference or not. When there is any pair having no difference between the rates, the cluster is regarded as a full inspection target so that inspection targets 3a to be added newly are calculated.

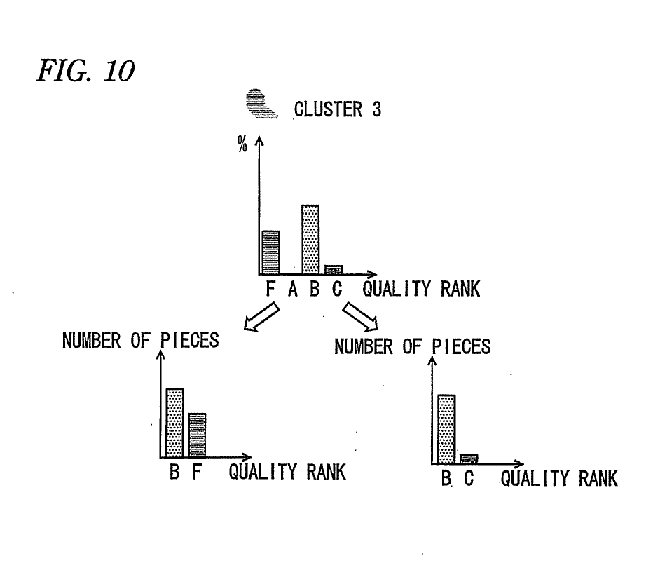

On this occasion, for example, verification can be performed by a null hypothesis on the assumption that “there is no difference between the rates”. In FIG. 10, components 3 of quality ranks B, F and C are distributed in the cluster in descending order of probability. When the most frequent quality rank B is used as a key to be paired with other quality ranks, a pair (B, F) and a pair (B, C) are obtained. Then, a significant probability p value in each pair is calculated.

Fore example, in a test at a significant level of 5%, when the thus calculated significant probability p value is smaller than 0.05, the aforementioned assumption is rejected so that determination can be made that “it cannot be said that there is no difference between the rates”. When the calculated significant probability p value is not smaller than 0.05, determination can be made that “there is no difference between the rates”.

Accordingly, when there is any pair on which the assumption is rejected in the aforementioned test, the inspection target calculator 70 sets the cluster as a full inspection target.

In accordance with the quality estimation apparatus according to this embodiment, ambiguity over the estimated values estimated by the clustering module 100 can be reduced so that more accurate quality ranks of components 3 can be estimated.

### Third Embodiment

A quality estimation apparatus according to this embodiment adds inspection targets 3a newly from estimation targets 3b when inspection targets having the inspection flag set as “yes” in inspection designation data are so defective that inspection cannot be made.

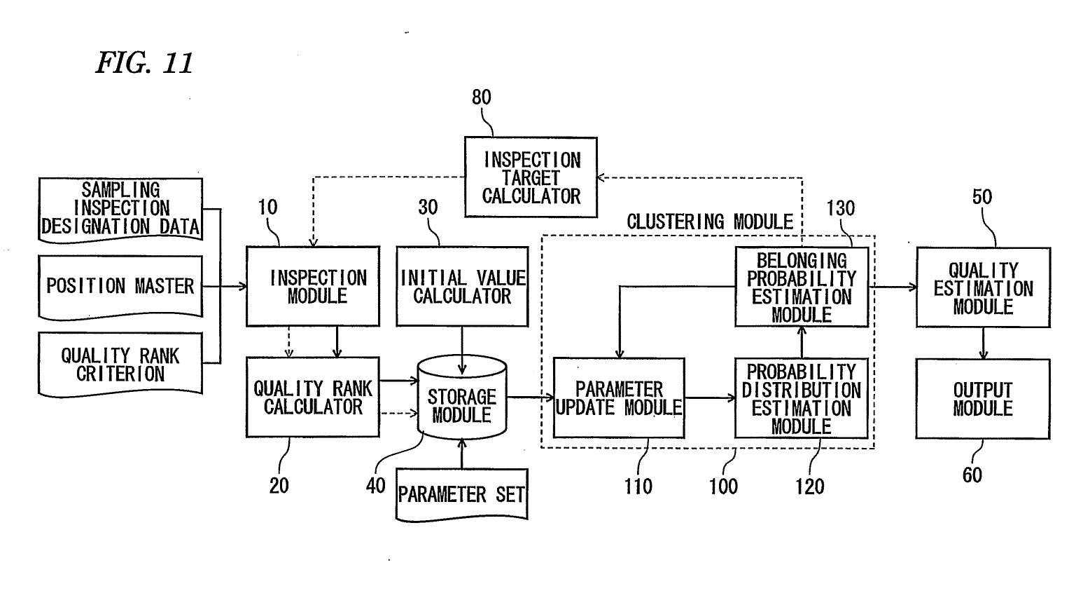

FIG. 11 is a block diagram of the quality estimation apparatus according to this embodiment. Incidentally, the same parts in configuration as those in the first embodiment are referred to by the same numerals for the sake of omission of description.

The quality estimation apparatus according to this embodiment has, in addition to the configuration of the quality estimation apparatus according to the first embodiment, an inspection target calculator 80 which calculates inspection targets 3a to be added newly.

For example, the inspection target calculator 80 uses four adjacent components 3 as a combination and calculates inspection targets 3a to be added newly, based on non-coincidence of quality ranks of the four components 3.

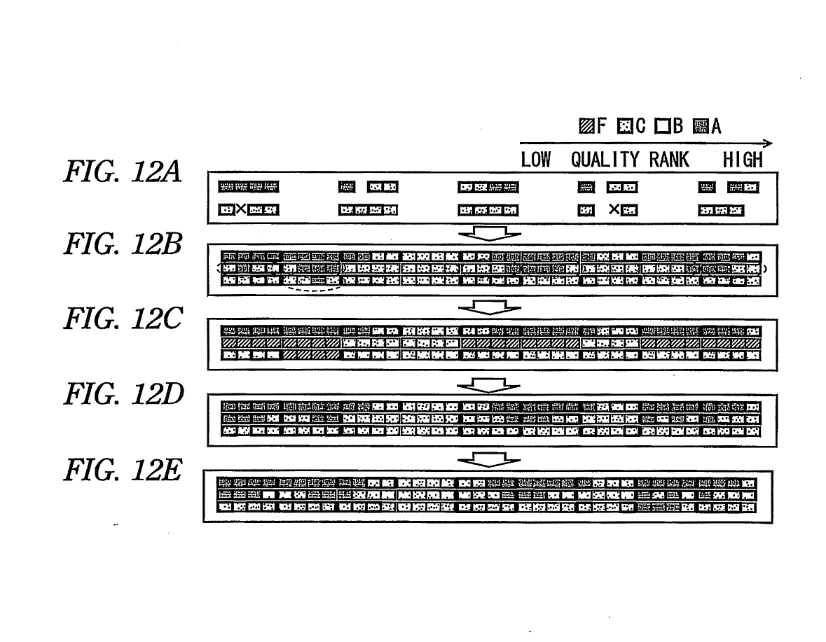

Operation of the inspection target calculator 80 will be described below in detail with reference to FIGS. 12A to 12E.

FIG. 12A shows quality ranks of inspection targets 3a when sampling inspection is performed initially. FIG. 12B shows a state where quality ranks of components 3 are estimated by the clustering module 100.

In this embodiment, inspection targets 3a initially designated for inspection are defective (components as represented by X in FIG. 12A). Accordingly, quality ranks estimated by the clustering module 100 as shown in FIG. 12B contain ambiguity compared with the case where all inspection targets 3a can be inspected.

Therefore, non-coincidence of quality ranks of four components 3 which have been not inspected yet is obtained. It is found from FIG. 12B that quality ranks of four components 3 in each of seven places are non-coincident with one another.

In this embodiment, four components 3 in each of the seven places are set as new inspection targets 3a (components hatched in FIG. 12C) and component ID's are delivered to the inspection module 10 so that sampling inspection is performed newly on the four components 3. FIG. 12D shows quality ranks of the components 3 after the new inspection.

A result of the new inspection is used as an input, so that quality ranks are estimated by the clustering module 100. FIG. 12E shows quality ranks estimated by the clustering module 100.

The inspection target calculator 80 repeats the aforementioned process until the result converges into a value or by a predetermined number of times.

Accordingly, even when inspection targets 3a are defective initially, ambiguity of estimated values of quality ranks can be reduced so that more accurate quality ranks of components 3 can be estimated.

In accordance with the quality estimation apparatus according to at least one of the aforementioned embodiments, more accurate qualities of all components formed on a wafer can be estimated by minimum sampling inspection at the time of processing of one wafer without necessity of prior knowledge.

While certain embodiment has been described, the embodiment has been presented by way of example only, and is not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A quality estimation apparatus comprising:
a storage module configured to store designation information for designating inspection targets to be subjected to sampling inspection in estimation targets including the inspection targets and non-inspection targets, characteristic values obtained by the sampling inspection of the inspection targets and criterion information for determining qualities of the inspection targets based on the characteristic values;
a threshold value calculator configured to calculate threshold values indicating qualities of the inspection targets from the characteristic values of the inspection targets by using the criterion information; and
a clustering module configured to classify the estimation targets in clusters so that the clusters have probability distributions with the threshold values used as a variable.

2. The apparatus of claim 1, wherein the clustering module includes:
an update module configured to update parameters concerned with the clusters;
a first probability calculator configured to calculate a first probability which is a probability of belonging of each estimation target to one of the clusters, by using the parameters;
a second probability calculator configured to calculate an expected value of the first probability distribution of the cluster and a second probability which is a probability that a second probability distribution of the threshold values of the inspection targets present in the neighborhood of the estimation target coincides with the first probability distribution, by using the threshold values; and
a third probability calculator configured to calculate a third probability which is a probability of belonging of the estimation target to the cluster by multiplying the expected value, the first probability and the second probability or adding logarithms of the expected value, the first probability and the second probability.

3. The apparatus of claim 2, wherein:
the clustering module is configured to estimate threshold values for the non-inspection targets respectively; and
the apparatus further comprises a threshold value estimation module configured to use the cluster of the highest third probability as a belonging cluster to which the estimation target belongs, and to estimate a threshold value of the highest probability in the first probability distribution of the belonging cluster as a threshold value of the estimation target.

4. The apparatus of claim 2 further comprising:
an inspection target calculator configured to calculate inspection targets to be added newly, wherein:
the inspection target calculator is configured to measure a difference between probabilities of threshold values of the cluster and to set the estimation target belonging to the cluster as an inspection target newly when it is determined that there is no difference between the probabilities of the threshold values.

5. The apparatus of claim 3 further comprising:
an inspection target calculator configured to calculate inspection targets to be added newly, wherein:
the inspection target calculator is configured to measure a difference between probabilities of threshold values of the cluster and to set the estimation target belonging to the cluster as an inspection target newly when it is determined that there is no difference between the probabilities of the threshold values.

6. The apparatus of claim 2 further comprising:
an inspection target calculator configured to calculate inspection targets to be added newly, wherein:
the inspection target calculator is configured to compare the threshold value of the estimation target with a threshold value of another estimation target in the neighborhood of the estimation target and to set the other estimation target in the neighborhood of the estimation target as an inspection target newly when the threshold value of the estimation target does not coincide with the threshold value of the other estimation target in the neighborhood of the estimation target.

7. The apparatus of claim 3 further comprising:
an inspection target calculator configured to calculate inspection targets to be added newly, wherein:
the inspection target calculator is configured to compare the threshold value of the estimation target with a threshold value of another estimation target in the neighborhood of the estimation target and to set the other estimation target in the neighborhood of the estimation target as an inspection target newly when the threshold value of the estimation target does not coincide with the threshold value of the other estimation target in the neighborhood of the estimation target.

8. A quality estimation method in the apparatus of claim 2, comprising:
calculating a threshold value indicating quality of an inspection target from the characteristic value of the inspection target by using the criterion information;
updating parameters concerned with the cluster;
calculating a first probability which is a probability of belonging of the estimation target to the cluster, by using the parameters;
calculating an expected value of the first probability distribution of the cluster and a second probability which is a probability that the second probability distribution of the threshold values of the inspection targets present in the neighborhood of the estimation target coincides with the first probability distribution, by using the threshold values of the inspection targets; and
calculating a third probability which is a probability of belonging of the estimation target to the cluster, by multiplying the expected value, the first probability and the second probability or adding logarithms of the expected value, the first probability and the second probability.

9. A non-transitory computer-readable medium storing a program that causes a computer to execute the method of claim 8.

10. A quality estimation apparatus comprising:
a storage module configured to store designation information for designating inspection targets to be subjected to sampling inspection in estimation targets including the inspection targets and non-inspection targets, characteristic values obtained by the sampling inspection of the inspection targets and criterion information for determining qualities of components based on the characteristic values;
a threshold value calculator configured to calculate threshold values indicating qualities of the inspection targets from the characteristic values of the inspection targets by using the criterion information; and
a clustering module configured to classify the estimation targets in clusters so that the clusters have probability distributions with the threshold values used as a variable,
wherein the clustering module includes:
an update module configured to update parameters concerned with a probability process;
a first probability calculator configured to calculate a first probability which is a probability of belonging of the estimation target to the cluster, by using the parameters;
a second probability calculator configured to calculate likelihood of the inspection targets belonging to the cluster and a second probability which is a probability that a second probability distribution of the threshold values of the inspection targets present in the neighborhood of the estimation target will coincide with the first probability distribution, by using the threshold values of the inspection targets; and
a third probability calculator configured to calculate a third probability which is a probability of belonging of the estimation target to the cluster by multiplying the likelihood, the first probability and the second probability or adding logarithms of the likelihood, the first probability and the second probability.

11. A quality estimation method in the apparatus of claim 10, comprising:
calculating a threshold value indicating quality of an inspection target from the characteristic value of the inspection target by using the criterion information;
updating parameters concerned with the cluster;
calculating a first probability which is a probability of belonging of the estimation target to the cluster, by using the parameters;
calculating likelihood of the inspection targets belonging to the cluster and a second probability which is a probability that the probability distribution of the threshold values of the inspection targets present in the neighborhood of the estimation target will coincide with the second probability distribution of the cluster, by using the threshold values of the inspection targets; and
calculating a third probability which is a probability of belonging of the estimation target to the cluster, by multiplying the likelihood, the first probability and the second probability or adding logarithms of the likelihood, the first probability and the second probability.

12. A non-transitory computer-readable medium storing a program that causes a computer to execute the method of claim 11.
